(19) United States
(12) Patent Application Publication
(10) Pub. No.: US 2026/0281041 A1
(43) Pub. Date: Sep. 17, 2026

(54) TRAFFIC LOAD OFFLOADING METHOD AND APPARATUS, DEVICE, AND READABLE MEDIUM

(71) Applicant: CLOUD INTELLIGENCE ASSETS HOLDING (SINGAPORE) PRIVATE LIMITED, Singapore (SG)

(72) Inventors: Jun WANG, Hangzhou (CN); Gang HUANG, Beijing (CN); Qingjie ZHAO, Beijing (CN)

(21) Appl. No.: 19/157,292

(22) PCT Filed: Apr. 25, 2024
(86) PCT No.: PCT/CN2024/089802

§ 371 Date: Aug. 15, 2025

(30) Foreign Application Priority Data
Apr. 27, 2023 (CN) 202310489320.7

(51) Int. Cl. H04L 47/125; H04L 67/1029; H04L 67/1031

(52) U.S. Cl. CPC H04L 47/125; H04L 67/1029; H04L 67/1031

(57) ABSTRACT

The present invention discloses a traffic load offloading method, including: receiving a traffic load, and sending the traffic load to a corresponding partition based on a partition allocation table; monitoring a traffic load value of each of partitions, and determining, based on the traffic load value, whether a partition becomes a hotspot partition; in response to that the partition becomes the hotspot partition, launching, in an idle partition, a part of instances in the hotspot partition, and offloading a corresponding traffic load in the hotspot partition to the idle partition after the launch is completed; and updating the partition allocation table based on a change of a partition in which the instances are located, and sending a newly received traffic load to a corresponding partition based on the updated partition allocation table. The present invention further discloses a corresponding apparatus, a computer device, and a medium. The present invention ensures service availability, immediate effectiveness of traffic migration, and high utilization of system computing resources in a migration process, and guarantees a stable end-to-end delay of service traffic in the migration process.

### CROSS-REFERENCE TO RELATED APPLICATIONS

This application is a National Stage of International Application No. PCT/CN2024/089802, filed on Apr. 25, 2024, which claims priority to Chinese Patent Application No. 202310489320.7, filed with the China National Intellectual Property Administration on Apr. 27, 2023 and entitled “TRAFFIC LOAD OFFLOADING METHOD AND APPARATUS, DEVICE, AND READABLE MEDIUM”. These applications are incorporated herein by reference in their entireties.

### TECHNICAL FIELD

The present disclosure pertains to the field of distributed system technologies, and in particular, to a traffic load offloading method and apparatus, a device, and a readable medium.

### BACKGROUND

A multi-tenant distributed computing system provides a fully-managed serverless computing service for users, a function computing system architecture maintains a master-worker-partition mechanism, and a system load carrier is a partition. A master is a system scheduling component of the distributed system. A worker is a worker node, each worker corresponds to one system application module, and each system application module may have a plurality of workers. A system load is divided into various partitions, and the partitions are scheduled by the system scheduling component, master, to be loaded onto workers to provide external services. Due to performance bottlenecks of module components in the system, as service scale increases, a single-machine worker may experience hotspot traffic. In this case, load balancing management needs to be performed on a hotspot of the system. The load balancing management involves how to process a hotspot, and also involves a traffic load offloading process.

Currently, common traffic load offloading methods in the industry include immediate migration, multi-batch migration, and greedy migration. The three solutions are not applicable to requirements of a function computing system in three aspects of availability, immediacy, and resource utilization during traffic load offloading. In the immediate migration, migration is directly performed without considering impact of a cold start, directly affecting service quality during load migration. In the multi-batch migration, a part of immediacy is sacrificed, but the service quality is still damaged during migration because the impact of the cold start still exists, which is unacceptable for a delay-sensitive online service. In the greedy migration, a quantity of alive instances and consumed resources are doubled, the pressure brought to the downstream is also doubled, the migration costs become high, and the stability is affected to some extent.

The information disclosed in the background part is only intended to enhance the understanding of the general background of the present disclosure, and should not be regarded as an admission or any form of suggestion that the information constitutes the prior art known to those skilled in the art.

### SUMMARY

An objective of the present disclosure is to provide a traffic load offloading method and apparatus, a device, and a readable medium, to implement lossless offloading of migrated target traffic in a distributed computing system, ensure service availability, instant validity of traffic migration, and high utilization of system computing resources in a migration process, and guarantee a stable end-to-end delay of service traffic in the migration process.

Based on the foregoing objective, an aspect of embodiments of the present disclosure provides a traffic load offloading method including the following steps: receiving a traffic load, and sending the traffic load to a corresponding partition based on a partition allocation table; monitoring a traffic load value of each of partitions, and determining, based on the traffic load value, whether a partition becomes a hotspot partition; in response to that the partition becomes the hotspot partition, launching, in an idle partition, a part of instances in the hotspot partition, and offloading a corresponding traffic load in the hotspot partition to the idle partition upon completion of the launch; and updating the partition allocation table based on a change of a partition in which the part of instances are located, and sending a newly received traffic load to a corresponding partition based on the updated partition allocation table.

In some implementations, the method further includes: shutting down, in the hotspot partition, the part of instances launched in the idle partition.

In some implementations, the method further includes: allocating different service entity objects to corresponding partitions based on a traffic load status of each partition; and constructing the partition allocation table based on a mapping relationship between the different service entity objects and the corresponding partitions, where the service entity objects include at least one of the following: a worker node, a user, a service, a function, or a version.

In some implementations, determining, based on the traffic load value, whether the partition becomes the hotspot partition includes: determining whether the traffic load value of the partition exceeds a first preset value, and determining, in response to that the traffic load value exceeds the first preset value, that the partition becomes the hotspot partition; and in response to that the partition becomes the hotspot partition, launching, in the idle partition, the part of instances in the hotspot partition includes: in response to determining that the partition becomes the hotspot partition, launching, in the idle partition, the part of instances in the hotspot partition based on a first preset proportion.

In some implementations, the method further includes: determining, in response to that the traffic load value does not exceed the first preset value, whether the traffic load value exceeds a second preset value; determining, in response to that the traffic load value exceeds the second preset value, that the partition is about to become the hotspot partition; and launching, in the idle partition, the part of instances in the hotspot partition based on a second preset proportion, where the second preset value is less than the first preset value, and the second preset proportion is less than the first preset proportion.

In some implementations, launching, in the idle partition, the part of instances in the hotspot partition, and offloading the corresponding traffic load in the hotspot partition to the idle partition includes: launching, in the idle partition, the part of instances in the hotspot partition based on a first preset proportion, offloading the corresponding traffic load in the hotspot partition to the idle partition, and determining whether the hotspot partition changes to a normal partition; and repeating the foregoing steps in response to that the hotspot partition does not change to the normal partition; or completing traffic load offloading in response to that the hotspot partition changes to the normal partition.

In some implementations, updating the partition allocation table based on the change of the partition in which the part of instances are located includes: obtaining a service entity object corresponding to the offloaded traffic load offloaded from the hotspot partition to the idle partition, modifying a corresponding mapping relationship in the partition allocation table based on the service entity object, and adding an operation-and-maintenance state identifier to the corresponding service entity object; and deleting the operation-and-maintenance state identifier in response to completing traffic load offloading.

Another aspect of the embodiments of the present disclosure further provides a traffic load offloading apparatus. The apparatus includes: a receiving module, configured to receive a traffic load, and send the traffic load to a corresponding partition based on a partition allocation table; a scheduling module, configured to monitor a traffic load value of each of partitions, and determine, based on the traffic load value, whether a partition becomes a hotspot partition; a managing module, configured to in response to the partition becomes the hotspot partition, launch, in an idle partition, a part of instances in the hotspot partition, and offload a corresponding traffic load in the hotspot partition to the idle partition upon completion of the launch; and an operating-and-maintaining module, configured to update the partition allocation table based on a change of a partition in which the part of instances are located, and send a newly received traffic load to a corresponding partition based on the updated partition allocation table.

Still another aspect of the embodiments of the present disclosure further provides a computer device including at least one processor and a memory. The memory stores computer instructions runnable on the processor. The instructions, when executed by the processor, implement the steps of the foregoing method.

Still another aspect of the embodiments of the present disclosure further provides a computer-readable storage medium. The computer-readable storage medium stores a computer program, which, when executed by a processor, implements the steps of the foregoing method.

The present disclosure has at least the following beneficial technical effects. Load traffic is distributed by using a partition allocation table, which achieves an improvement in traffic monitoring efficiency, thereby improving immediacy of determining a hotspot partition and improving service stability. In a process of traffic load offloading, a part of instances are warmed up in an idle partition in advance, and then a part of traffic is offloaded to the idle partition according to a bearing capacity of the warmed-up instances in the idle partition, ensuring that no negative impact is caused to user service performance in the process, realizing lossless offloading of migrated target traffic in a distributed computing system, ensuring service availability, immediate effectiveness of the traffic migration, and high utilization rate of system computing resources in a migration process, and guaranteeing a stable end-to-end delay of the service traffic in the migration process.

### BRIEF DESCRIPTION OF DRAWINGS

To describe technical solutions in the embodiments of the present disclosure or in the prior art more clearly, the following briefly describes accompanying drawings required for describing embodiments or the prior art. Apparently, the accompanying drawings in the following descriptions show only some embodiments of the present disclosure, and a person of ordinary skill in the art may still derive other embodiments from these accompanying drawings without creative efforts.

FIG. 1 is a schematic diagram of an embodiment of a traffic load offloading method according to the present disclosure.

FIG. 2 is a system block diagram of an embodiment of a traffic load offloading method according to the present disclosure.

FIG. 3 is a schematic diagram of an embodiment of a traffic load offloading apparatus according to the present disclosure.

FIG. 4 is a schematic diagram of an embodiment of a computer device according to the present disclosure.

FIG. 5 is a schematic diagram of an embodiment of a computer-readable storage medium according to the present disclosure.

### DESCRIPTION OF EMBODIMENTS

To make the objectives, technical solutions, and advantages of the present disclosure clear and comprehensible, embodiments of the present disclosure are described in detail below, but it should be understood that, the protection scope of the present disclosure is not limited to the specific implementations.

It should be noted that, expressions using “first” and “second” in the embodiments of the present disclosure are intended to distinguish between two distinct entities or distinct parameters having the same name. It may be learned that “first” and “second” are merely for ease of expression and should not be understood as a limitation to the embodiments of the present disclosure. This explanation will not be repeated in subsequent embodiments.

Unless otherwise explicitly indicated, throughout the specification and claims, the term “include” or its variations such as “comprise” or “including” will be understood as including the stated elements or components and not exclude other elements or components.

To make a person skilled in the art understand the technical solutions provided in the embodiments of this application, the following briefly describes the related technologies. In a function computing system, partitions serve as carriers of system load and are scheduled by a system scheduling component, master, to actual worker nodes, workers. Workers load target partitions to provide external services. In addition, traffic loads are allocated to partitions, for example, through hash allocation according to a user ID, a service ID, a function ID, or the like. However, in an actual service process, a system side needs to adjust a partition allocation relationship in time according to a traffic load change status, to offload traffic between different partitions, thereby achieving load balancing and optimal performance and avoiding a hotspot. Generally, service quality is directly affected by adjustment of the partition allocation relationship. Traffic load instantly surges from an old partition to a new partition, but at this time, a service in the new partition has not been completely launched, and the launch needs to take a certain amount of time. Therefore, a request delay and a success rate are both affected during this period.

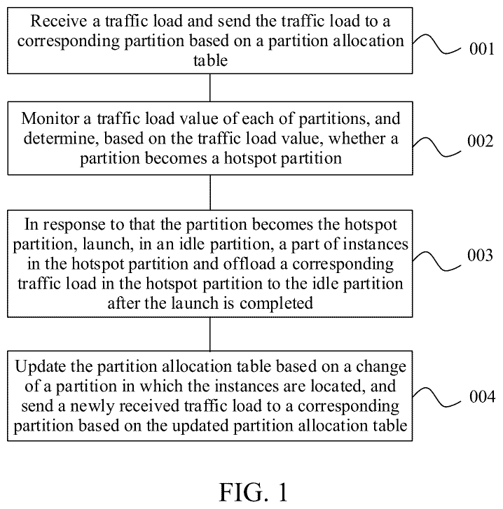

Based on the foregoing objective, a first aspect of the embodiments of the present disclosure provides an embodiment of a traffic load offloading method. FIG. 1 shows a schematic diagram of an embodiment of a traffic load offloading method according to the present disclosure. As shown in FIG. 1, the traffic load offloading method in this embodiment of the present disclosure includes the following steps.
001: Receive a traffic load, and send the traffic load to a corresponding partition based on a partition allocation table.

In this embodiment, a front-end gateway component receives service traffic, and accurately routes and allocates the traffic to each partition based on the partition allocation table. When a function request corresponding to the received service traffic is normal, the traffic is allocated to each partition in a random and equal distribution scheduling manner. The partition allocation table records a mapping relationship between service entity objects and partitions, and each component synchronizes traffic load scheduling across a plurality of partitions based on the table, to implement global traffic and load scheduling and allocation.
002: Monitor a traffic load value of each of partitions, and determine, based on the traffic load value, whether a partition becomes a hotspot partition.

In this embodiment, the traffic load value of each partition is monitored, whether a partition becomes a hotspot partition is determined based on the traffic load value. It is determined whether a traffic load value of a partition exceeds a first preset value, and in response to that the traffic load value exceeds the first preset value, it is determined that the partition becomes the hotspot partition. When there is a hotspot, a part of the traffic load in the hotspot partition is offloaded to another idle partition, to reduce the load of the original partition.

In this embodiment, the hotspot partition is defined relative to a normal partition and the idle partition. The traffic load values of the partitions are in order as follows: the traffic load value of the hotspot partition is greater than the traffic load value of the normal partition, and the traffic load value of the normal partition is greater than the traffic load value of the idle partition. The division of the hotspot partition, the normal partition, and the idle partition may be division based on an instance distribution proportion of each partition, may be division based on a preset traffic load value, or may be in other manners based on the traffic load and beneficial to traffic load balancing.
003: In response to that the partition becomes the hotspot partition, launch, in an idle partition, a part of instances in the hotspot partition and offload a corresponding traffic load in the hotspot partition to the idle partition after the launch is completed.

In this embodiment, when there is a hotspot, a part of instances are launched in an idle partition in advance, and after the launch is completed, a part of the traffic load in the hotspot partition is offloaded to other idle partition, to avoid a cold start. By performing rolling migration of the instances between different partitions, the traffic load is also proportionally allocated between old and new partitions along with the migration of the instances, thereby avoiding doubling of resource consumption and a quantity of alive instances. As the traffic load on the old partition decreases, idle instances may be gradually taken offline and recycled, so that costs basically remain unchanged. During the migration, the service is lossless, the costs basically remain unchanged, and immediacy and stability are ensured.

In this embodiment, a quantity of the part of instances may be determined based on a quantity of instances in the hotspot partition and an expected quantity of instances, may be determined based on the quantity of instances in the idle partition, may be determined based on an instance distribution status in all partitions, or may be determined in any other manner beneficial to the traffic load offloading.
004: Update the partition allocation table based on a change of a partition in which the instances are located, and send a newly received traffic load to a corresponding partition based on the updated partition allocation table.

In this embodiment, the partition corresponding to the instances whose partition changes is updated in the partition allocation table. Specifically, the hotspot partition before the instances are offloaded is changed to the idle partition after the instances are offloaded.

In this embodiment, for an online and stateful distributed service scenario, violent offloading is not performed, and a multi-batch offloading manner is not used. Instead, instances are warmed up in advance, thereby completely avoiding impact caused by a cold start of a service during the offloading, and greatly guaranteeing that service quality is not impaired. To avoid additional resource consumption and downstream pressure, a rolling offloading manner based on a proportion is used. When a load is offloaded from an old partition to a new partition, a certain quantity of service instances are launched in advance in the new partition, and the same quantity of instances are removed from the old partition. Then, the traffic load is proportionally offloaded according to a ratio of the quantity of instances between the old partition and the new partition. This guarantees lossless offloading of traffic, ensures that resource consumption and downstream pressure will not be doubled, and also ensures a certain degree of immediacy due to the rolling offloading.

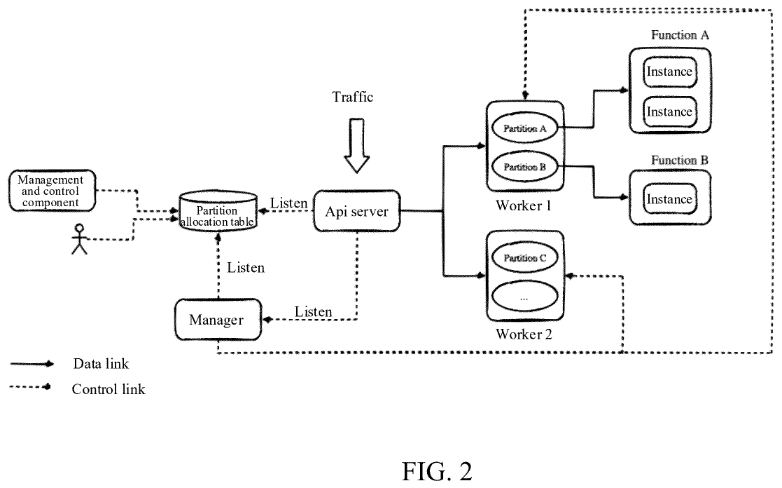

In this embodiment, FIG. 2 shows a system block diagram of an embodiment of a traffic load offloading method according to the present disclosure. As shown in FIG. 2, a management and control component (master) is a partition scheduling component on a system side, and adjusts partitions in real time based on load statuses of loads of partitions, to achieve the purpose of load balancing. A supportable strategy includes a worker node (worker) level, a user level, a service level, a function level, a version level, and the like. The partition allocation table records a mapping relationship between service entity objects (a user, a service, a function, a version) and partitions, and the components synchronize traffic load scheduling among the plurality of partitions based on the table, to implement global traffic and load scheduling and allocation. An api server (interface service) is a front-end gateway component of the system. The component is stateless, and a main role is to receive service traffic, and accurately route and allocate the traffic to each partition based on the partition allocation table. When a function is in a normal state, the traffic is allocated to each partition in a random and equal distribution scheduling manner.

In some embodiments of the present disclosure, the method further includes: shutting down, in the hotspot partition, the part of instances launched in the idle partition.

In this embodiment, when a load is offloaded from an old partition to a new partition, a certain quantity of service instances are launched in advance in the new partition, and the same quantity of instances are removed from the old partition. This not only guarantees lossless offloading of traffic, but also ensures that resource consumption and downstream pressure will not be doubled, and meanwhile ensures a certain degree of immediacy due to rolling offloading.

In some embodiments of the present disclosure, the method further includes: allocating different service entity objects to corresponding partitions based on a traffic load status of each partition; and constructing the partition allocation table based on a mapping relationship between the different service entity objects and the corresponding partitions, where the service entity objects include at least one of the following: a worker node, a user, a service, a function, or a version.

In this embodiment, the partition scheduling component on the system side adjusts partitions in real time based on load statuses of loads of the partitions, to achieve load balancing. Service traffic is routed to each partition based on the partition allocation table. Entries of the table may be constructed based on different types of entities (the worker node, the user, the service, the function, an alias). Hash values of IDs of different types of entities to target Partition partitions are used as Tokens (identifiers), to store routing relationships between entities and different Partitions, thereby implementing a traffic allocation strategy at different levels (the user level, the service level, the function level).

In some embodiments of the present disclosure, determining, based on the traffic load value, whether the partition becomes a hotspot partition includes: determining whether the traffic load value of the partition exceeds a first preset value, and determining, in response to that the traffic load value exceeds the first preset value, that the partition becomes the hotspot partition. In response to that the partition becomes the hotspot partition, launching, in an idle partition, a part of instances in the hotspot partition based on a preset proportion includes: in response to determining that the partition becomes the hotspot partition, launching, in the idle partition, the part of instances in the hotspot partition based on a first preset proportion.

In this embodiment, the system side needs to adjust a partition allocation relationship in time according to a traffic load change status, to offload traffic between different partitions, thereby achieving load balancing and optimal performance and avoiding a hotspot. When there is a hotspot, a part of the traffic load in the hotspot partition needs to be offloaded to another partition. In the offloading process, a part of instances are warmed up in a new partition in advance, and then a part of traffic is offloaded to the new partition according to a bearing capacity of the warmed-up instances in the new partition. This is repeated until it is ensured that no negative impact is caused to user service performance. In addition, as the traffic load in the old partition decreases, idle instances may be gradually taken offline and recycled, so that costs basically remain unchanged. It is greatly ensured that service quality during the offloading is not affected, thereby implementing lossless offloading. In addition, operation-and-maintenance personnel do not need to worry about impact on user services when the hotspot is processed, thereby improving system stability to some extent.

In some embodiments of the present disclosure, the method further includes: further determining, in response to that the traffic load value does not exceed the first preset value, whether the traffic load value exceeds a second preset value; determining, in response to that the traffic load value exceeds the second preset value, that the partition is about to become the hotspot partition; and launching, in the idle partition, the part of instances in the hotspot partition based on a second preset proportion, where the second preset value is less than the first preset value, and the second preset proportion is less than the first preset proportion.

In this embodiment, to avoid generation of a hotspot, the preset value may be properly reduced, that is, the second preset value is set. If the traffic load value exceeds the second preset value, the traffic load is offloaded in advance based on the second preset proportion. In the offloading process, a part of instances are warmed up in a new partition in advance, and then a part of traffic is offloaded to the new partition according to a bearing capacity of the warmed-up instances in the new partition. This is repeated until it is ensured that no negative impact is caused to user service performance.

In some embodiments of the present disclosure, the launching, in an idle partition, a part of instances in the hotspot partition based on a preset proportion, and offloading a corresponding traffic load in the hotspot partition to the idle partition includes: launching, in the idle partition, the part of instances in the hotspot partition based on a first preset proportion, offloading the corresponding traffic load in the hotspot partition to the idle partition, and determining whether the hotspot partition changes to a normal partition; and repeating the foregoing steps in response to that the hotspot partition does not changes to the normal partition; or completing traffic load offloading in response to that the hotspot partition changes to the normal partition.

In this embodiment, in the migration process, a part of instances are warmed up in a new partition in advance, and then a part of traffic is offloaded to the new partition according to a bearing capacity of the warmed-up instances in the new partition. This is repeated until the hotspot partition changes to a normal partition, to ensure that no negative impact is caused to user service performance in the process. A rolling traffic offloading strategy is implemented. As service instances are launched in a target partition one by one, traffic is successively and proportionally offloaded to the target partition, and meanwhile, idle service instances in the current partition are reduced, to improve an offloading speed while ensuring service quality, thereby satisfying requirements for immediacy and resource utilization in some scenarios.

In some embodiments of the present disclosure, updating the partition allocation table based on the hotspot partition and the idle partition includes: obtaining a service entity object corresponding to the offloaded traffic load offloaded from the hotspot partition to the idle partition, modifying a corresponding mapping relationship in the partition allocation table based on the service entity object, and adding an operation-and-maintenance state identifier to the corresponding service entity object; and deleting the operation-and-maintenance state identifier in response to that traffic load offloading is completed.

In this embodiment, a concept of an operation-and-maintenance state is provided. During the operation-and-maintenance state, graceful offloading of the traffic load is completed to distinguish a normal state from the operation-and-maintenance state of each system component. Normal service traffic without an operation-and-maintenance state identifier is allocated to each partition in a random and equal distribution scheduling manner. Lossless migration of traffic is guaranteed, and high performance of system components is also guaranteed.

It should be particularly noted that, steps in the embodiments of the foregoing traffic load offloading method may be mutually intersected, replaced, added, or deleted. Therefore, the proper permutations, combinations, and changes to the traffic load offloading method shall also fall within the protection scope of the present disclosure and shall not limit the protection scope of the present disclosure to the embodiments.

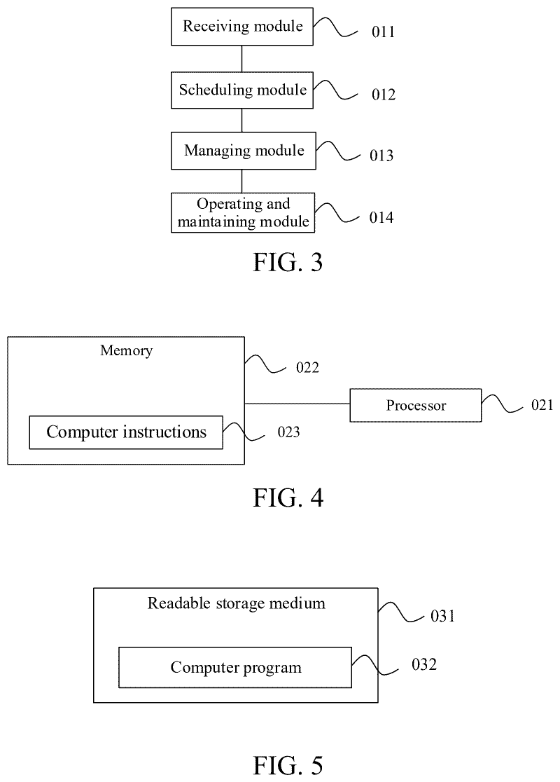

Based on the foregoing objective, a second aspect of the embodiments of the present disclosure provides a traffic load offloading apparatus. FIG. 3 shows a schematic diagram of an embodiment of a traffic load offloading apparatus according to the present disclosure. As shown in FIG. 3, the traffic load offloading apparatus in this embodiment of the present disclosure includes the following modules: a receiving module 011, configured to receive a traffic load, and send the traffic load to a corresponding partition based on a partition allocation table; a scheduling module 012, configured to monitor a traffic load value of each of partitions, and determine, based on the traffic load value, whether a partition becomes a hotspot partition; a managing module 013, configured to in response to that the partition becomes the hotspot partition, launch, in an idle partition, a part of instances in the hotspot partition, and offload a corresponding traffic load in the hotspot partition to the idle partition after the launch is completed; and an operating and maintaining module 014, configured to update the partition allocation table based on a change of a partition in which instances are located, and send a newly received traffic load to a corresponding partition based on the updated partition allocation table.

Based on the foregoing objective, a third aspect of the embodiments of the present disclosure provides a computer device. FIG. 4 shows a schematic diagram of an embodiment of a computer device according to the present disclosure. As shown in FIG. 4, the computer device in this embodiment of the present disclosure includes the following apparatuses: at least one processor 021 and a memory 022. The memory 022 stores computer instructions 023 runnable on the processor. The instructions, when executed by the processor, implement the steps of the foregoing method.

The present disclosure further provides a computer-readable storage medium. FIG. 5 shows a schematic diagram of an embodiment of a computer-readable storage medium according to the present disclosure. As shown in FIG. 5, a computer-readable storage medium 031 stores a computer program 032. When the computer program 032 is executed by a processor, the steps of the foregoing method are performed.

Finally, it should be noted that a person of ordinary skill in the art may understand that all or part of the processes implementing the method in the foregoing embodiments may be implemented by a computer program instructing related hardware. A program of the traffic load offloading method may be stored in a computer-readable storage medium. When the program is executed, the processes of the forgoing method embodiments are implemented. The storage medium of the program may be a magnetic disk, an optical disc, a read-only memory (ROM), a random access memory (RAM), or the like. Embodiments of the foregoing computer program can achieve effects the same as or similar to those of any corresponding foregoing method embodiments.

In addition, the method disclosed according to the embodiments of the present disclosure may also be implemented as a computer program executed by a processor, and the computer program may be stored in a computer-readable storage medium. When the computer program is executed by the processor, the foregoing functions defined in the method disclosed in the embodiments of the present disclosure are performed.

In addition, the foregoing method steps and system units may also be implemented by using a controller and a computer-readable storage medium that is configured to store a computer program causing the controller to implement functions of the foregoing steps or units.

A person skilled in the art will also understand that the various exemplary logical blocks, modules, circuits, and algorithm steps described in combination with the present disclosure may be implemented as electronic hardware, computer software, or a combination thereof. To clearly describe the interchangeability between hardware and software, various schematic components, blocks, modules, circuits, and steps have been generally described with reference to functions of the components, blocks, modules, circuits, and steps. Whether the functions are implemented as software or hardware depends on a specific application and a design constraint imposed on an entire system. A person skilled in the art may implement the functions for each specific application in various manners, but the implementation decision should not be interpreted as causing a departure from the scope disclosed by the embodiments of the present disclosure.

In one or more exemplary designs, the functions may be implemented in hardware, software, firmware, or any combination thereof. If the functions are implemented in the software, the functions may be stored as one or more instructions or code on a computer-readable medium or transmitted through a computer-readable medium. The computer-readable medium includes a computer storage medium and a communication medium. The communication medium includes any medium that helps to transfer a computer program from one location to another location. The storage medium may be any available medium accessible to a general-purpose or dedicated computer. As a non-limiting example, the computer-readable medium may include a RAM, a ROM, an EEPROM, a CD-ROM or another optical disc storage device, a magnetic disk storage device or another magnetic storage device, or any other medium that can be used to carry or store required program code in a form of instructions or a data structure and that is accessible to the general-purpose or dedicated computer or a general-purpose or dedicated processor. In addition, any connection may be properly referred to as a computer-readable medium. For example, if software is sent from a website, a server, or another remote source by using a coaxial cable, an optical fiber cable, a twisted pair, a digital subscriber line (DSL), or a wireless technology like an infrared ray, radio, or a microwave, the foregoing coaxial cable, optical fiber cable, twisted pair, DSL, or wireless technology like the infrared ray, radio, or the microwave are all included in the definition of the medium. As used herein, the magnetic disk and the optical disc include a compact disc (CD), a laser disk, a digital versatile disc (DVD), a floppy disk, and a blu-ray disc. The magnetic disk usually reproduces data magnetically, and the optical disc reproduces data optically by using a laser. A combination of the foregoing content should also be included in the scope of the computer-readable medium.

The foregoing is exemplary embodiments of the present disclosure, but it should be noted that, various changes and modifications may be made without departing from the scope of the embodiments of the present disclosure as defined by the claims. The functions, steps, and/or actions of the method claims according to the embodiments described herein do not need to be performed in any particular order. In addition, although elements disclosed in the embodiments of the present disclosure may be described or required in an individual form, unless explicitly limited to a singular form, the elements may also be understood as a plurality.

It should be understood that, unless an exception is clearly supported in the context, a singular form “an” used herein is intended to include a plural form. It should also be understood that, the term “and/or” used herein is any or all possible combinations including one or more associated listed items.

The sequence numbers of the embodiments disclosed in the foregoing embodiments of the present disclosure are merely for the description purpose, and do not imply the preference among embodiments.

A person of ordinary skill in the art may understand that all or part of the steps of the foregoing embodiments may be implemented by using hardware or may be implemented by a program instructing relevant hardware. A program may be stored in a computer-readable storage medium. The foregoing storage medium may be a read-only memory, a magnetic disk, an optical disc, or the like.

A person of ordinary skill in the art should understand that the discussion of any embodiment above is merely exemplary, and is not intended to imply that the scope (including the claims) disclosed in the embodiments of the present disclosure is limited to the examples. Under the idea of the embodiments of the present disclosure, technical features of the foregoing embodiments or different embodiments may also be combined, and many other variations exist in different aspects of the foregoing embodiments of the present disclosure. The variations are not provided in details for brevity. Therefore, any omission, modification, equivalent replacement, or improvement made within the spirit and principle of the embodiments of the present disclosure all shall fall within the protection scope of the embodiments of the present disclosure.

1. A traffic load offloading method, comprising following steps:
receiving a traffic load, and sending the traffic load to a corresponding partition based on a partition allocation table;
monitoring a traffic load value of each of partitions, and determining, based on the traffic load value, whether a partition becomes a hotspot partition;
in response to that the partition becomes the hotspot partition, launching, in an idle partition, a part of instances in the hotspot partition, and offloading a corresponding traffic load in the hotspot partition to the idle partition upon completion of the launch; and
updating the partition allocation table based on a change of a partition in which the part of instances are located, and sending a newly received traffic load to a corresponding partition based on the updated partition allocation table.

2. The traffic load offloading method according to claim 1, further comprising:
shutting down, in the hotspot partition, the part of instances launched in the idle partition.

3. The traffic load offloading method according to claim 1, further comprising:
allocating different service entity objects to corresponding partitions based on a traffic load status of each partition; and
constructing the partition allocation table based on a mapping relationship between the different service entity objects and the corresponding partitions, wherein
the service entity objects comprise at least one of the following: a worker node, a user, a service, a function, or a version.

4. The traffic load offloading method according to claim 1, wherein determining, based on the traffic load value, whether the partition becomes the hotspot partition comprises:
determining whether the traffic load value of the partition exceeds a first preset value, and determining, in response to that the traffic load value exceeds the first preset value, that the partition becomes the hotspot partition; and
in response to that the partition becomes the hotspot partition, launching, in the idle partition, the part of instances in the hotspot partition comprises:
in response to determining that the partition becomes the hotspot partition, launching, in the idle partition, the part of instances in the hotspot partition based on a first preset proportion.

5. The traffic load offloading method according to claim 4, further comprising:
determining, in response to that the traffic load value does not exceed the first preset value, whether the traffic load value exceeds a second preset value;
determining, in response to that the traffic load value exceeds the second preset value, that the partition is about to become the hotspot partition; and
launching, in the idle partition, the part of instances in the hotspot partition based on a second preset proportion, wherein
the second preset value is less than the first preset value, and the second preset proportion is less than the first preset proportion.

6. The traffic load offloading method according to claim 1, wherein launching, in the idle partition, the part of instances in the hotspot partition, and offloading the corresponding traffic load in the hotspot partition to the idle partition comprises:
launching, in the idle partition, the part of instances in the hotspot partition based on a first preset proportion, offloading the corresponding traffic load in the hotspot partition to the idle partition, and determining whether the hotspot partition changes to a normal partition; and
repeating the foregoing steps in response to that the hotspot partition does not change to the normal partition; or
completing traffic load offloading in response to that the hotspot partition changes to the normal partition.

7. The traffic load offloading method according to claim 1, wherein updating the partition allocation table based on the change of the partition in which the part of instances are located comprises:
obtaining a service entity object corresponding to the offloaded traffic load offloaded from the hotspot partition to the idle partition, modifying a corresponding mapping relationship in the partition allocation table based on the service entity object, and adding an operation-and-maintenance state identifier to the corresponding service entity object; and
deleting the operation-and-maintenance state identifier in response to that traffic load offloading is completed.

8. (canceled)

9. A computer device, comprising:
at least one processor; and
a memory, wherein the memory stores computer instructions runnable on the processor, and the computer instructions, when executed by the processor, implement the following steps:
receiving a traffic load, and sending the traffic load to a corresponding partition based on a partition allocation table;
monitoring a traffic load value of each of partitions, and determining, based on the traffic load value, whether a partition becomes a hotspot partition;
in response to that the partition becomes the hotspot partition, launching, in an idle partition, a part of instances in the hotspot partition, and offloading a corresponding traffic load in the hotspot partition to the idle partition upon completion of the launch; and
updating the partition allocation table based on a change of a partition in which the part of instances are located, and sending a newly received traffic load to a corresponding partition based on the updated partition allocation table.

10. A computer-readable storage medium, wherein the computer-readable storage medium stores a computer program, and the computer program, when executed by a processor, implements the following steps:
receiving a traffic load, and sending the traffic load to a corresponding partition based on a partition allocation table;
monitoring a traffic load value of each of partitions, and determining, based on the traffic load value, whether a partition becomes a hotspot partition;
in response to that the partition becomes the hotspot partition, launching, in an idle partition, a part of instances in the hotspot partition, and offloading a corresponding traffic load in the hotspot partition to the idle partition upon completion of the launch; and
updating the partition allocation table based on a change of a partition in which the part of instances are located, and sending a newly received traffic load to a corresponding partition based on the updated partition allocation table.

11. The computer device according to claim 9, wherein the computer instructions, when executed by the processor, implement the following steps:
shutting down, in the hotspot partition, the part of instances launched in the idle partition.

12. The computer device according to claim 9, wherein the computer instructions, when executed by the processor, implement the following steps:
allocating different service entity objects to corresponding partitions based on a traffic load status of each partition; and
constructing the partition allocation table based on a mapping relationship between the different service entity objects and the corresponding partitions, wherein
the service entity objects comprise at least one of the following: a worker node, a user, a service, a function, or a version.

13. The computer device according to claim 9, wherein the computer instructions, when executed by the processor, implement the following steps:
determining whether the traffic load value of the partition exceeds a first preset value, and determining, in response to that the traffic load value exceeds the first preset value, that the partition becomes the hotspot partition; and
in response to determining that the partition becomes the hotspot partition, launching, in the idle partition, the part of instances in the hotspot partition based on a first preset proportion.

14. The computer device according to claim 13, wherein the computer instructions, when executed by the processor, implement the following steps:
determining, in response to that the traffic load value does not exceed the first preset value, whether the traffic load value exceeds a second preset value;
determining, in response to that the traffic load value exceeds the second preset value, that the partition is about to become the hotspot partition; and
launching, in the idle partition, the part of instances in the hotspot partition based on a second preset proportion, wherein
the second preset value is less than the first preset value, and the second preset proportion is less than the first preset proportion.

15. The computer device according to claim 9, wherein the computer instructions, when executed by the processor, implement the following steps:
launching, in the idle partition, the part of instances in the hotspot partition based on a first preset proportion, offloading the corresponding traffic load in the hotspot partition to the idle partition, and determining whether the hotspot partition changes to a normal partition; and
repeating the foregoing steps in response to that the hotspot partition does not change to the normal partition; or
completing traffic load offloading in response to that the hotspot partition changes to the normal partition.

16. The computer device according to claim 9, wherein the computer instructions, when executed by the processor, implement the following steps:
obtaining a service entity object corresponding to the offloaded traffic load offloaded from the hotspot partition to the idle partition, modifying a corresponding mapping relationship in the partition allocation table based on the service entity object, and adding an operation-and-maintenance state identifier to the corresponding service entity object; and
deleting the operation-and-maintenance state identifier in response to that traffic load offloading is completed.

17. The computer-readable storage medium according to claim 10, wherein the computer program, when executed by the processor, implements the following steps:
shutting down, in the hotspot partition, the part of instances launched in the idle partition.

18. The computer-readable storage medium according to claim 10, wherein the computer program, when executed by the processor, implements the following steps:
allocating different service entity objects to corresponding partitions based on a traffic load status of each partition; and
constructing the partition allocation table based on a mapping relationship between the different service entity objects and the corresponding partitions, wherein
the service entity objects comprise at least one of the following: a worker node, a user, a service, a function, or a version.

19. The computer-readable storage medium according to claim 10, wherein the computer program, when executed by the processor, implements the following steps:
determining whether the traffic load value of the partition exceeds a first preset value;
determining, in response to that the traffic load value exceeds the first preset value, that the partition becomes the hotspot partition; and in response to determining that the partition becomes the hotspot partition, launching, in the idle partition, the part of instances in the hotspot partition based on a first preset proportion;
determining, in response to that the traffic load value does not exceed the first preset value, whether the traffic load value exceeds a second preset value; determining, in response to that the traffic load value exceeds the second preset value, that the partition is about to become the hotspot partition; and launching, in the idle partition, the part of instances in the hotspot partition based on a second preset proportion, wherein the second preset value is less than the first preset value, and the second preset proportion is less than the first preset proportion.

20. The computer-readable storage medium according to claim 10, wherein the computer program, when executed by the processor, implements the following steps:
launching, in the idle partition, the part of instances in the hotspot partition based on a first preset proportion, offloading the corresponding traffic load in the hotspot partition to the idle partition, and determining whether the hotspot partition changes to a normal partition; and
repeating the foregoing steps in response to that the hotspot partition does not change to the normal partition; or
completing traffic load offloading in response to that the hotspot partition changes to the normal partition.

21. The computer-readable storage medium according to claim 10, wherein the computer program, when executed by the processor, implements the following steps:
obtaining a service entity object corresponding to the offloaded traffic load offloaded from the hotspot partition to the idle partition, modifying a corresponding mapping relationship in the partition allocation table based on the service entity object, and adding an operation-and-maintenance state identifier to the corresponding service entity object; and
deleting the operation-and-maintenance state identifier in response to that traffic load offloading is completed.
